(19) United States
(12) Patent Application Publication
(10) Pub. No.: US 2015/0036121 A1
(43) Pub. Date: Feb. 5, 2015

(54) Method for Measuring the Scattered Light of Particles in a Medium

(71) Applicants: Dirk Kurowski, Gevelsberg (DE); Christian Vesper, Dortmund (DE); Gert Blankenstein, Cambridge, MA (US)

(72) Inventors: Dirk Kurowski, Gevelsberg (DE); Christian Vesper, Dortmund (DE); Gert Blankenstein, Cambridge, MA (US)

(73) Assignee: BOEHRINGER INGELHEIM MICROPARTS GMBH, Dortmund (DE)

(21) Appl. No.: 14/127,337

(22) PCT Filed: Jul. 2, 2012
(86) PCT No.: PCT/EP2012/062864

§ 371 Date: May 9, 2014

(30) Foreign Application Priority Data
Jul. 5, 2011 (EP) 11172776.4

(51) Int. Cl. G01N 21/51; G01N 15/06

(52) U.S. Cl. CPC G01N 21/51; G01N 15/06; G01N 2015/0693; G01N 2021/4726
USPC 356/51; 356/338; 356/339

(57) ABSTRACT

The invention relates to a method for measuring the scattered light (L2) of particles (P, PK) in a measuring medium (F), wherein a measuring container (1) is supplied with the measuring medium (F) and incident light (L1) is shone through the measuring medium (F) at least in some regions over a certain path length (1) and in a certain direction and the light (L2) scattered from the incident light (L1) is measured within a certain angle range (α).

It is provided according to the invention that the incident light (L1) is guided parallel to a longitudinal axis (S) of the measuring container (1).

By these measures, known methods can be improved and it is readily possible to use the invention even for very small measuring volumes of the measuring medium (F) with the associated small dimensions of the measuring container (1).

The invention relates to a method for measuring the scattered light of particles in a measuring medium, wherein a measuring container is supplied with the measuring medium and incident light is shone through the measuring medium at least in some regions over a certain path length and in a certain direction and the light scattered from the incident light is measured within a certain angle range.

The majority of known turbidimeters operate by such a method. The turbidity is the conventional term for an optical phenomenon caused by the scattering of light on suspended (undissolved) particles which are present in a medium (for example in a liquid).

When a beam of light hits a particle, it is reflected, scattered or absorbed, depending on the size, shape and colour of the particle. According to the particle shape and surface nature, the light is scattered with different degrees of intensity in all directions.

Thus, by measuring the turbidity, conclusions can be drawn as to the purity of a measuring medium.

Turbidity measurements are therefore used in numerous applications. Thus, turbidity measurement has an important value in the process/quality control of all kinds of branches of industry such as, for example, the food industry, water treatment, and the cosmetic and chemical industries. In medical diagnostics, for example, antigen or antibody reactions (such as blood clotting) and the state of protein compounds in body fluids are determined by measuring turbidity.

The turbidimetry of measuring media such a liquids, for example, is carried out in the prior art either by absorption measurements (transmitted-light measurements) or by scattered light measurements.

In transmitted-light measurement, a focused beam of light is passed through the measuring medium and the loss of light from the transmitted beam is determined. The scattering coefficient thus determined corresponds to the totality of the scattered light taken from the incident light beam.

In scattered light measurement, a light-sensitive detector is arranged on an axis along which scattered light is to be measured. The majority of conventional turbidimeters measure by the so-called 90° scattering method, i.e. where the detector for measuring the scattered light is positioned at an angle of 90° to the axis of the incident light beam.

The measurement of light passing through is only suitable for greater degrees of turbidity, whereas scattered light measurement is preferably used for less turbid situations, i.e. low particle concentrations.

Turbidimeters used in the pharmaceutical laboratory sector therefore generally operate by the 90° scattering method. Conventional turbidimeters typically require measuring volumes of more than 10 ml, which is not appropriate particularly in the case of expensive sample liquids (e.g. highly pure protein solutions) as this is a waste of valuable sample liquid.

Thus, measuring arrangements for turbidimetry are desirable which can be used even with very much smaller measuring volumes than in commercial laboratory equipment.

The basic problem in conventional measuring arrangements is that the distance travelled by the incident light in the volume of medium to be measured in the case of the measurement volumes conventional in laboratory procedures is too short, particularly at low turbidity values, to produce sufficient “scatter potential” for a measurement. This risk naturally increases as the volume of sample or measurement volume decreases. A further problem is that small sample volumes also require small measuring containers (cuvettes), thus causing disruptive scattering on the walls of the cuvettes. Light signals are then generated which may be comparable with the signals of the actual turbidity measurement and therefore lead to errors of measurement.

In order to be able to measure turbidity comparatively, a turbidity standard liquid “formazine” was created which can easily be reproduced from commercially obtainable chemicals according to a recipe in ISO standard 7027. This enables satisfactory calibration of turbidimetry equipment.

The following may be mentioned as the most common units for turbidity which relate to dilutions of the liquid of formazine:

FNU (Formazine Nephelometric Units, measuring of scattered light at an angle of 90° according to ISO 7027), FAU (Formazine Attenuation Units, transmitted-light measurement at an angle of 0° according to ISO 7027), FTU (Formazine Turbidity Unit, used in water preparation), NTU (Nephelometric Turbidity, measurement of scattered light at an angle of 90° according to USA Regulations) and TE/F (Turbidity Unit/Formazine; German unit used in water preparation).

Light in the invisible wavelength range (for example 650 nanometres or 860 nanometres) is used as the measuring light.

From DE 2847712 A1 a turbidity measuring apparatus is known which operates by a method having the features of the preamble of claim 1. The turbidity measuring apparatus comprises a housing which can accommodate a tubular measuring container and also a light source by which light beams are released at right angles to the longitudinal axis of the measuring container. A light-sensitive detector is aligned within the housing at right angles to the incident light beam and centrally with respect to a scattered light axis. To reduce the sensitivity of the turbidity measuring apparatus to light signals that cannot be put down to scattered light, such as for example internal reflections of the incident light beam and possibly ambient light reaching the detector, a number of optical shields (shutters) are provided around the detector and also around the measuring container in a specific spatial arrangement.

The turbidity measuring apparatus shown in this document is, however, unsuitable for very small measuring volumes which are sometimes preferred in the pharmaceutical laboratory sector.

The invention is thus based on the problem of improving a method according to the preamble of claim 1 and providing an apparatus suitable for this purpose, which is suitable for the turbidity measurement of, in particular, very small measuring volumes that occur in the pharmaceutical laboratory sector.

This problem is solved by the charactering features of claims 1 and 8.

Advantageous further features and embodiments of the invention can be inferred from the respective subclaims.

The invention therefore starts from a method for measuring the scattered light of particles in a measuring medium, wherein a measuring container is acted upon by the measuring medium and incident light is shone through the measuring medium at least in some regions over a certain path length and in a certain direction and the light scattered from the incident light is measured within a certain angle range.

It is provided according to the invention that the incident light is guided parallel to a longitudinal axis of the measuring container.

This makes it possible, in an astoundingly simple manner, to achieve a satisfactory measurement of turbidity even with very small measuring volumes which accordingly demand small measuring containers. Even with a measuring container of very small capacity, for example about 100 μl, it is possible to achieve a path length for the incident light beam through the measuring medium which is adequate for proper measurement. Thus, for example, a cuvette with an internal diameter of 3 mm and a volume of 100 μl of measuring liquid allows a path length for the light in the sample of around 14 mm. A further advantage of this measuring method is that disruptive boundary surfaces through which the incident light beam passes (particularly in the region of the walls of a measuring container) are very much further away from one another by this method than in known measuring arrangements.

According to a highly expedient embodiment of the inventive concept, it is also envisaged that the incident light is guided along the axis of symmetry of the measuring container. This makes it possible to achieve the greatest possible distance from the boundary surfaces of the measuring container even at right angles to the incident light beam, which leads to a reduction in the reflection of the scattered light from the boundary surfaces to the wall of the measuring container. The scattered light can thus also be coupled out of the measuring container more satisfactorily.

It has also proved advantageous if the scattered light is measured at an angle of about 90° to the incident light. This allows great sensitivity of measurement even with low turbidity values, i.e. when only a few or very small particles are present.

The sensitivity of measurement of the method can be further increased if the scattered light is focused before the measurement. This can be done, for example, by means of a simple optical device such as e.g. a collimator lens or an objective. In this way the scattered light can easily be deflected on to a photodetector, for example, when even large scattering angles of the scattered light can still be detected by the photodetector. The angle of aperture of the detector is thus virtually increased. In addition, by focusing the said optical device onto the incident light beam, disruptive reflections and scatterings on the boundary surfaces of the measuring container for the detector are minimised.

According to a further feature of the invention, for focusing the scattered light, an optical device is used having an aperture which is smaller than the path length of the incident light through the measuring medium. The aperture of the optical device is aligned so as to stand roughly in the centre of the above-mentioned path length. This also helps to reduce disruptive reflections and scatterings on boundary surfaces of the measuring container (air/liquid; liquid/measuring container base) for the detector.

It has been found that the use of a rotationally symmetrical, particularly cylindrical measuring container yields optimum measuring results. This leads to very good coupling out of the scattered light from the measuring container.

At the same time it is expedient to use the light from a laser as the light, as this enables monochromatic and, in particular, parallel light beams to be produced. The light beams can thus be adjusted very accurately in a measuring arrangement. Preferably, the wavelength of the laser light used is in the near infrared range (NIR), i.e. at a wavelength of between about 780 to 3000 nm.

As already mentioned, the invention also relates to a device for carrying out the method according to the invention.

The invention here starts from a device comprising at least one receptacle for a measuring container that can be filled with a measuring medium, at least one light source for producing at least one light beam incident in the measuring container and at least one detector for measuring scattered light.

For carrying out the method according to the invention it is now proposed according to the invention that in the device the light produced has a beam path which runs at least partly parallel to a longitudinal axis of a measuring container located in the receptacle.

According to a further feature of the device it may be envisaged that in the beam path at least one deflector unit is provided for deflecting the light beam, particularly through 90°. A deflector unit of this kind may for example be in the form of a prism or mirror. The advantage is that, for example, this enables the overall height of the device to be reduced.

However, it is alternatively possible to use a beam splitter, in which a part of the light beam emitted for the measurement is guided onto a second detector before being introduced into the measuring container and then the optical output of the incident light beam can be monitored by means of a corresponding evaluating unit. By comparing the input and output signal, any variations in the output of the light source can thus be compensated or adjusted.

Moreover, expediently, an optical device for focusing the scattered light is provided in front of the detector. The optical device may be, for example, a collimator lens or an objective. As already mentioned, the angle of aperture of the detector for incident scattered light can be virtually increased in this way, eventually leading to an increase in the sensitivity of measurement of the device.

To make it possible to use rotationally symmetrical measuring containers in conjunction with the device, the receptacle of the device should expediently also be suitable for holding rotationally symmetrical measuring containers.

For attenuating scatter on boundary surfaces for the detector, a measuring container may be adapted to be inserted in the receptacle so that an aperture of the optical device is smaller than a path length of a light beam passing through the measuring medium and incident into the measuring container and the aperture is aligned substantially centrally along the said path length.

Further advantages and embodiments of the invention will become clear from embodiments by way of example, as will be illustrated by means of the attached drawings, wherein:

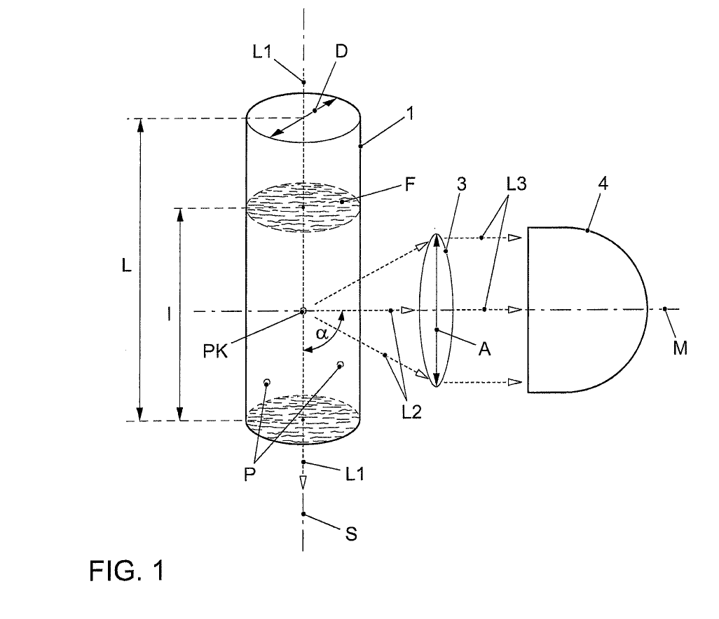

FIG. 1 is a schematic representation of the method according to the invention,

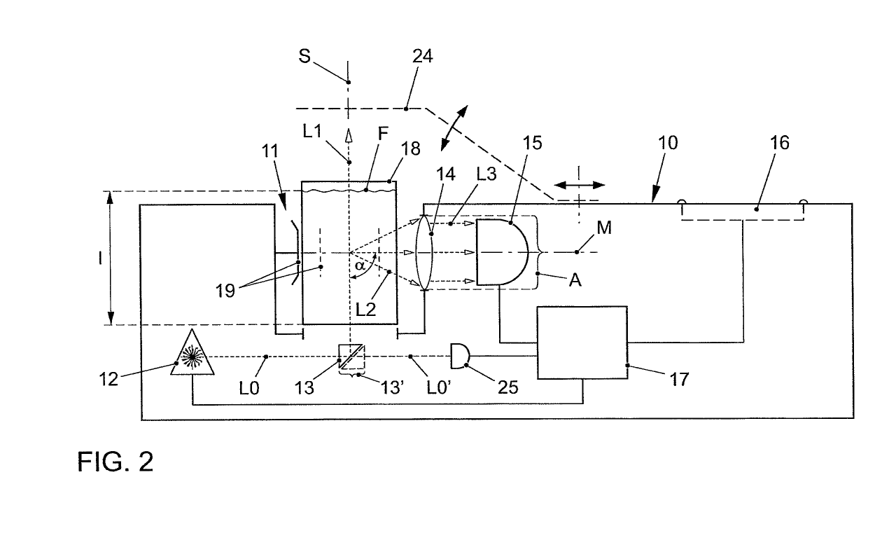

FIG. 2 is a schematic representation of a device according to the invention for carrying out the method according to the invention and,

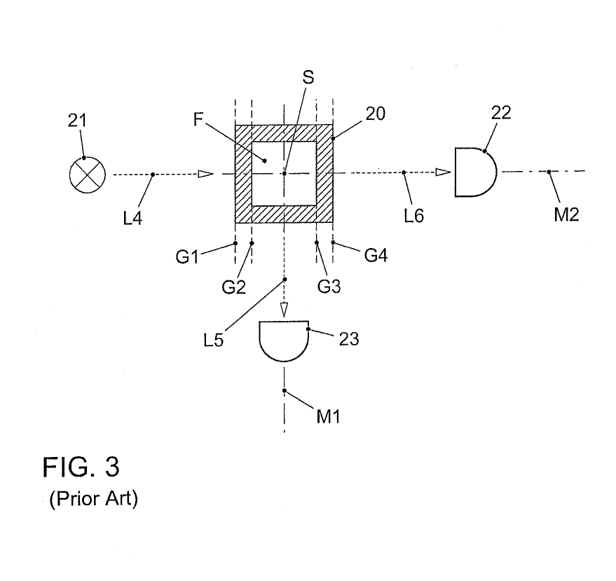

FIG. 3 is a schematic representation of known methods according to the prior art.

First of all, reference will be made to FIG. 1.

This figure shows a cylindrical measuring container 1 of diameter D and length L. The measuring container 1 is partly filled with a measuring liquid F.

Undissolved particles P are present in the liquid F, causing turbidity of the liquid F.

The following procedure is used to measure the turbidity of the liquid F:

Using a suitable light source (not shown) a light beam L1 incident into the measuring container 1 or into the liquid S is produced. The incident light beam L1 travels a distance I through the liquid S.

It is apparent that the incident light beam L1 is guided parallel to a longitudinal axis of symmetry S of the measuring container 1, particularly along this axis of symmetry S.

By way of example, a collision particle PK is particularly shown, at which the incident light beam L1 is scattered. This produces scattered light beams L2, which are focused by means of a collimator lens 3 to form light beams L3 and are thus directed on to a detector 4 (for example a photodiode). The detector 4 is aligned along a measuring axis M which is at an angle α of about 90° to the incident light beam L1.

It is also apparent that the measuring method is carried out such that the distance I travelled by the incident light L1 through the liquid F is greater than an aperture A of the collimator lens 3. The aperture A of the collimator lens 3 is aligned substantially centrally with respect to the path length I.

Referring now to FIG. 2, a turbidimeter 10 is shown. The turbidimeter 10 comprises a receiving opening 11 for receiving a cylindrical measuring container 18. Retaining elements 19 are provided for securing the measuring container 18, these elements 19 abutting on different circumferential points of the measuring container 18.

The measuring container 18 is partly filled with a liquid F that is to be measured.

In order to carry out a measurement the user can now start a suitable measuring programme by means of an input unit 16 (for example a pressure-sensitive LCD monitor, a so-called touchscreen).

The information input by the user is processed by a suitable control, storage and evaluating unit 17 and causes a laser unit 12 to emit a light beam L0 over a predetermined measure period. The light beam L0 is deflected by means of an optical deflector unit 13 in the form a prism through 90°, such that a light beam L1 is incident in the measuring container 18 and hence in the liquid F and shines through them.

Alternatively (as shown by dashed lines) the deflector unit 13 may also be in the form of a beam splitter (13′), for example, which leads to a splitting of the light beam L0 into a light beam L0′ and the light beam L1. The split-off light beam L0′ can then be directed on to a detector 25 connected to the evaluating unit 17.

In this way the optical performance of the ingoing light beam L0 can be monitored. By comparing the input and output signal, fluctuations in the performance of the laser unit 12 can thus be compensated or adjusted.

It will be seen that the light beam L1 is guided through an axis of symmetry S of the cylindrical measuring container 18. At the same time the light beam L1 travels a distance I though the liquid F. For measuring the turbidity on the basis of particles located in the liquid F, a detector 15 in the form of a photodiode is arranged along a measuring axis M which is arranged at an angle α of about 90° to the light beam L1. This detector 15 is connected to the control, storage and evaluating unit 17 for signalling purposes.

Light beams L2 scattered in the liquid F are focused by a collimator lens 14 arranged in front of the detector 15 and having an aperture A towards the latter to form light beams L3. It is clear that the aperture A has been chosen to be smaller than the distance I travelled by the light beam L1 to the liquid F, the measuring container 18 having been inserted in the receiving opening 11 such that the aperture A is aligned substantially centrally with respect to said path length I.

In addition it may be envisaged that an interference filter (not shown) is arranged in front of the detector 15, the transmission range of which corresponds to the wavelength of the laser light. This can reduce sensitivity to extraneous light which does not come from the laser unit 12.

In addition, a protective cover 24 is provided that shields the user from any light radiation L1 emitted. The protective cover 24 is flexible and/or movable (cf. the double arrows) to enable the measuring container 18 to be inserted in the receiving opening 11 in spite of the protective cover 24.

In conjunction with FIG. 3 the known prior art will finally be discussed in brief.

The figure shows a measuring container 20 in which liquid F to be measured is contained. In order to measure the turbidity of the liquid F, a light beam L4 is first produced by means of a light source 21, this beam L4 entering the measuring container 20 and re-emerging from it as a transmitted light beam L6. The intensity of the transmitted light beam L6 is measured by a detector 22, from which the turbidity of the liquid F can be deduced. The detector 22 is arranged along a measuring axis M2 which coincides with the axis of the light beam L4. Thus transmitted-light measurement is achieved in principle.

The mode of operation of scattered light measurement is also illustrated in principle. A detector 23 is arranged along a measuring axis M1 which is arranged at an angle of about 90° to the axis of the light beam L4. The detector 23 measures light beams L5 produced on the basis of scattering in the liquid F. The measuring container 20 is a cuvette with an axis of symmetry S.

Disruptive scattering and multiple reflections of the light beam L4 occur particularly at boundary surfaces G1 to G4 provided by the walls of the measuring container 20, and is this becomes more marked as the size of the measuring container 20 decreases.

### LIST OF REFERENCE NUMERALS

1. Measuring container
3. Collimator lens
4. Detector
10. Turbidimeters
11. Receiving opening
12. Laser unit
13. Deflector unit
13′ Beam splitter
14. Collimator lens
15. Detector (Photodiode)
16. Input unit
17. Control, storage and evaluating unit
18. Measuring container
19. Retaining elements
20. Measuring container
21. Light source
22. Detector
23. Detector
24. Protective cover
25. Detector
A Aperture of collimator lens
D Diameter of measuring container
F Liquid
G1-G4 Boundary surfaces
I Distance travelled by the incident light through the liquid
L Length of measuring container
L0 Light beam
L0′ Light beam split off
L1 Incident light beam
L2 Scattered light beam
L3 Focused light beam
L4 Incident light beam
L5 Scattered light beam
L6 Transmitted light beam
M Measuring axis for scattered light
M1 Measuring axis for scattered light
M2 Measuring axis for transmitted light
P Particle
PK Collision particle
S Axis of symmetry of the measuring container
α Angle between incident light beam and measuring axis for scattered light

1. Method for measuring the scattered light (L2) of particles (P, PK) in a measuring medium (F), wherein a measuring container (1, 18) is supplied with the measuring medium (F) and incident light (L1) is shone through the measuring medium (F) at least in some regions over a certain path length (I) and in a certain direction (S) and the light (L2) scattered from the incident light (L1) is measured (4, 15) within a certain angle range (α), characterised in that the incident light (L1) is guided parallel to a longitudinal axis (S) of the measuring container (1, 18).

2. Method according to claim 1, characterised in that the incident light (L1) is guided along the axis of symmetry (S) of the measuring container (1, 18).

3. Method according to claim 1, characterised in that the scattered light (L2) is measured at an angle (α) of about 90° to the incident light (L1).

4. Method according to claim 1, characterised in that the scattered light (L2) is focused (3, L3) before a measurement (4).

5. Method according to claim 4, characterised in that an optical device (3) with an aperture (A) is used to focus the scattered light (L2), the aperture being smaller than the path length (I) of the incident light (L1) through the measuring medium (F) and the aperture (A) of the optical device (3) being aligned so that it (A) is located substantially centrally along said path length (I).

6. Method according to claim 1, characterised in that a rotationally symmetrical measuring container is used as the measuring container (1, 18).

7. Method according to claim 1, characterised in that the light of a laser, preferably with a wavelength in the near infrared range, is used as the light (L0, L1).

8. Apparatus (10) for carrying out a method for measuring the scattered light (L2) of particles (P, PK) in a measuring medium (F), wherein a measuring container (1, 18) is supplied with the measuring medium (F) and incident light (L1) is shone through the measuring medium (F) at least in some regions over a certain path length (I) and in a certain direction (S) and the light (L2) scattered from the incident light (L1) is measured (4, 15) within a certain angle range (α), characterised in that the incident light (L1) is guided parallel to a longitudinal axis (S) of the measuring container (1, 18), said apparatus comprising at least one receptacle (11) for a measuring container (18) that can be filled with a measuring medium (F), at least one light source (12) for producing at least one light beam (L1) that is incident in the measuring container (18) and at least one detector (15) for measuring scattered light (L2), characterised in that in the apparatus (10) the light (L0) produced has a beam path (L0, L1) which extends at least in parts (L1) parallel to a longitudinal axis (S) of a measuring container (18) located in the receptor (11).

9. Apparatus (10) according to claim 8, characterised in that in the beam path (L0, L1), at least one deflector unit (13) is provided for deflecting the light beam (L0) through 90°, in particular.

10. Apparatus (10) according to claim 8, characterised in that an optical device (14) for focusing (L3) the scattered light (L2) is provided in front of the detector (15).

11. Apparatus (10) according to claim 8, characterised in that the receptacle (11) is suitable for holding rotationally symmetrical measuring containers (18).

12. Apparatus (10) according to claim 10, characterised in that a measuring container (18) can be inserted in the receptacle (11) such that an aperture (A) of the optical device (14) is smaller than a path length (I) of a light beam (L1) incident in the measuring container (18) through the measuring medium (F) and the aperture (A) is aligned substantially centrally along said path length (I).

13. Apparatus (10) according to claim 8, characterised in that an interference filter is arranged in front of the detector (15), the transmission range of which corresponds to the wavelength of the light (L0) produced.
